(19) United States
(12) Patent Application Publication
(10) Pub. No.: US 2004/0186631 A1
(43) Pub. Date: Sep. 23, 2004

(54) Storage medium storing a shadow volume generation program, game device, and shadow volume generation method

(76) Inventor: Keizo Ohta, Kyoto (JP)

Correspondence Address: NIXON & VANDERHYE, P.C., 1100 N. GLEBE ROAD, 8TH FLOOR, ARLINGTON, VA, 22201, US

(21) Appl. No.: 10/635,652

(22) Filed: Aug. 7, 2003

(30) Foreign Application Priority Data
Mar. 17, 2003 (JP) 2003-72552

(51) Int. Cl. G06F 19/00

(52) U.S. Cl. 700/303

(57) ABSTRACT

Only a shadow casting object 2 is rendered using a light source placed in a virtual space as a viewpoint. As a result, a Z value corresponding to each pixel of a two-dimensional image of the object seen from the light source is written into a Z-buffer. After the rendering is completed, a mesh model 4 is generated from a plane object 3. That is, the Z value of a pixel corresponding to each vertex of the plane object 3 is read from the Z-buffer, and a Y-coordinate of each vertex is determined based on the read Z value. A shadow rendering process is executed according to a shadow volume technique using the mesh model 4 generated as described above. As such, it is possible to generate a shadow volume by a fixed and simple process without the need for exception handling.

### BACKGROUND OF THE INVENTION

1. Field of the Invention

The present invention relates to storage media storing a shadow volume generation program, game devices, and shadow volume generation methods. More particularly, the present invention relates to a storage medium storing a shadow volume generation program, a game device, and a shadow volume generation method, which are used for generating a shadow volume utilized in a shadow volume technique.

2. Description of the Background Art

A shadow volume technique is mainly used for representing a shadow. This technique generates a spatial model (hereinafter, this spatial model is called a “shadow volume”) corresponding to space where light cannot be seen because it is blocked by a shadow casting model, and renders the above-described spatial model in a special manner (this spatial model itself is not rendered), thereby darkening a shadowed model only in a portion residing within the spatial model. For example, if the shadow casting object is a sphere, the space where light cannot be seen because it is blocked by the sphere takes a cylindrical shape.

In the following descriptions, the shadow casting model is referred to as a “shadow object”.

In the above-described shadow volume technique, one of the problems is how to determine a shape of the shadow volume. The shape of the shadow volume varies depending on a shape animation of a shadow object or a change in a position of a light source.

Byway of example, a conventional method for determining a shape of the shadow volume will be described below. In the above-described conventional method, the shape of the shadow volume is determined based on an edge, which will be an outline of the shadow volume, shared between front-facing polygons and back-facing polygons of a shadow object seen from the light source.

For example, in the case where light rays fall on a slanted rectangular parallelepiped (shadow object) as shown in FIG. 15A, the shadow object seen from the light source is shown in FIG. 15B. In the conventional method, the front-facing polygons (FIG. 15C) and the back-facing polygons (FIG. 15D) of the shadow object are detected, respectively, and edges (solid line shown in FIG. 15E) shared between the front-facing polygons and the back-facing polygons are extracted. The extracted edges are used as an outline of a cross section of the shadow volume. That is, a prism-shaped model whose cross section has a shape shown in FIG. 15E in solid line is used as the shadow volume.

In the above-described conventional method, first of all, data describing surfaces sharing the edges and normal information of all the surfaces are required. Those data and information are not included in standard graphics data. Thus, it is necessary to generate a special data converter, and place the generated data converter into a memory.

Also, a dedicated processor cannot be realized due to the necessity to perform various exception handlings in an actual process. As a result, it is necessary to cause a CPU to perform a time-consuming process.

Specifically, an inner product between a normal of a surface including an edge and a light direction is calculated with respect to all edges, thereby selecting any edges shared between a surface facing toward the light source and a surface facing in the opposite direction. Among the selected edges, any edges sharing the same vertex are sequentially selected, thereby finally generating data of a loop-shaped line. The generated data is used as data indicating a cross section of the shadow volume. The above-described cross section is stretched in the direction of light so as to obtain a prism-shaped model, which is used as shape data of the shadow volume.

However, it is rare that a shadow volume is generated without difficulty in a manner as described above. For example, as shown in FIG. 16A, in the case where the shadow object has a surface parallel to the light source, that is, light rays fall on a rectangular parallelepiped from directly above, a plurality of edges can be selected as an outline, as shown in FIG. 16B. As a result, it is difficult to select a single outline. Also, as shown in FIG. 16C, in the case where slanting light rays fall on an object shaped like a snowman, a portion of its outline cannot be drawn, as shown in FIG. 16D, which results in the necessity of an additional process. Furthermore, as shown in FIG. 16E, in the case where light rays fall on the object shaped like a snowman from directly above, a plurality of outlines are detected. As a result, a plurality of shadow volumes are generated, thereby complicating a processing time.

In general, the above-described exceptional cases are not unusual. Therefore, it is necessary to prepare various types of exception handling programs or tailor the original data in various ways in order to handle those exceptional cases. However, it is very difficult to prepare various types of exception handling programs or tailor the original data in various ways, and the burden of those processes also becomes too heavy. Especially, in the case where a game image is generated by a game device, the game image has to be generated in one frame (1/30 seconds or 1/60 seconds), which makes it impossible to adopt the above-described overburdened processes. Thus, simple shape data is typically prepared for generating a shadow volume so as to prevent the occurrence of the above-described exceptional cases, and the shadow volume is generated using the prepared simple shape data. If a shadow is rendered in a manner as described above, however, the rendered shadow is different from the originally intended shadow due to substantial simplification.

### SUMMARY OF THE INVENTION

Therefore, an object of the present invention is to provide a storage medium storing a shadow volume generation program, a game device, and a shadow volume generation method, which are capable of generating a shadow volume by a simple and fixed process without the need for an exceptional process.

The present invention has the following features to attain the object mentioned above (notes in parentheses indicate exemplary elements which can be found in the embodiments to follow, though such notes are not intended to limit the scope of the invention).

A storage medium of the present invention is a computer-readable storage medium for storing a program that causes a computer (a CPU 10, a GPU 11) to generate a shadow volume (4) used for rendering a shadow cast by an object (2) placed in a three-dimensional virtual space. The shadow volume generation program causes the computer (the CPU 10, the GPU 11) to execute a step (S201) of writing a Z value corresponding to each pixel within a predetermined area including at least the shadow casting object (2), into a Z-buffer (15), using a light source placed in the virtual space as a viewpoint, and a step of generating the shadow volume (4) from a plane object (3) by determining (S206) a position (py) of each vertex of a plurality of polygons composing the plane object (3), which will be the shadow volume, with regard to a direction (Y-axis direction) perpendicular to a surface of the plane object in accordance with the Z value (Zvalue) of each pixel written in the Z-buffer (15).

A game device of the present invention generates a shadow volume (4) used for rendering a shadow cast by an object (2) placed in a three-dimensional virtual space, and comprises a Z-buffer (15), a Z value writing means (the CPU 10 or the GPU 11, which executes step S201), and a shadow volume generation means (the CPU 10 or the GPU 11, which executes step S204). The Z value writing means writes a Z value of each pixel within a predetermined area including at least the shadow casting object (2), into the Z-buffer (15), using a light source placed in the virtual space as a viewpoint. The shadow volume generation means generates the shadow volume (4) from a plane object (3) by determining a position (py) of each vertex of a plurality of polygons composing the plane object (3), which will be the shadow volume, with regard to a direction (Y-axis direction) perpendicular to a surface of the plane object in accordance with the Z value (Zvalue) of each pixel written in the Z-buffer (15) by the Z value writing means.

A shadow volume generation method of the present invention generates a shadow volume used for rendering a shadow cast by an object (2) placed in a three-dimensional virtual place, and comprises a Z value writing step (S201) and a shadow volume generation step (S204). In the Z value writing step, a Z value of each pixel within a predetermined area including at least the shadow casting object (2) is written into the Z-buffer (15) using a light source placed in the virtual space as a viewpoint. In the shadow volume generation step, the shadow volume (4) is generated from a plane object (3) by determining a position (py) of each vertex of a plurality of polygons composing the plane object (3), which will be the shadow volume, with regard to a direction (Y-axis direction) perpendicular to a surface of the plane object in accordance with the Z value (Zvalue) of each pixel written in the Z-buffer (15).

According to the present invention as described above, it is possible to generate a shadow volume by a simple and fixed process without the need for exception handling.

These and other objects, features, aspects and advantages of the present invention will become more apparent from the following detailed description of the present invention when taken in conjunction with the accompanying drawings.

### BRIEF DESCRIPTION OF THE DRAWINGS

FIGS. 1A to 1H are illustrations for describing the principles of the present invention;

FIGS. 2A and 2B are illustrations showing a relationship between a shadow volume and a shadow;

FIG. 3 is an illustration showing an external view of a game system according to a first embodiment of the present invention;

FIG. 4 is a block diagram showing the structure of a main unit 100;

FIG. 5 is a memory map of a DVD-ROM 300;

FIG. 6 is a flowchart showing a flow of a shadow rendering process;

FIG. 7 is a flowchart showing a flow of a shadow volume generation process;

FIGS. 8A to 8D are illustrations showing a concrete example of the shadow volume generation process;

FIG. 9 is an illustration showing a concrete example of a method for determining a Y-coordinate of each vertex of a mesh model based on a Z value;

FIGS. 10A to 10I are illustrations for describing a difference in process between a case where a light source is a parallel light source and a case where a light source is a point light source;

FIGS. 11A to 11D are illustrations showing a concrete example of a shadow rendering process using the shadow volume;

FIGS. 12A to 12C are illustrations showing a concrete example of a shadow volume generation process in a case where slanting light rays fall on a shadow casting object from above;

FIGS. 13A to 13D are illustrations showing a concrete example of a method for placing a shadow volume in a case where slanting light rays fall on a shadow casting object from above;

FIGS. 14A and 14B are illustrations showing a concrete example of a shadow volume generation process in a case where a flat object forms a part of a three-dimensional object;

FIGS. 15A to 15E are illustrations showing an outline extraction process of a conventional shadow volume technique; and

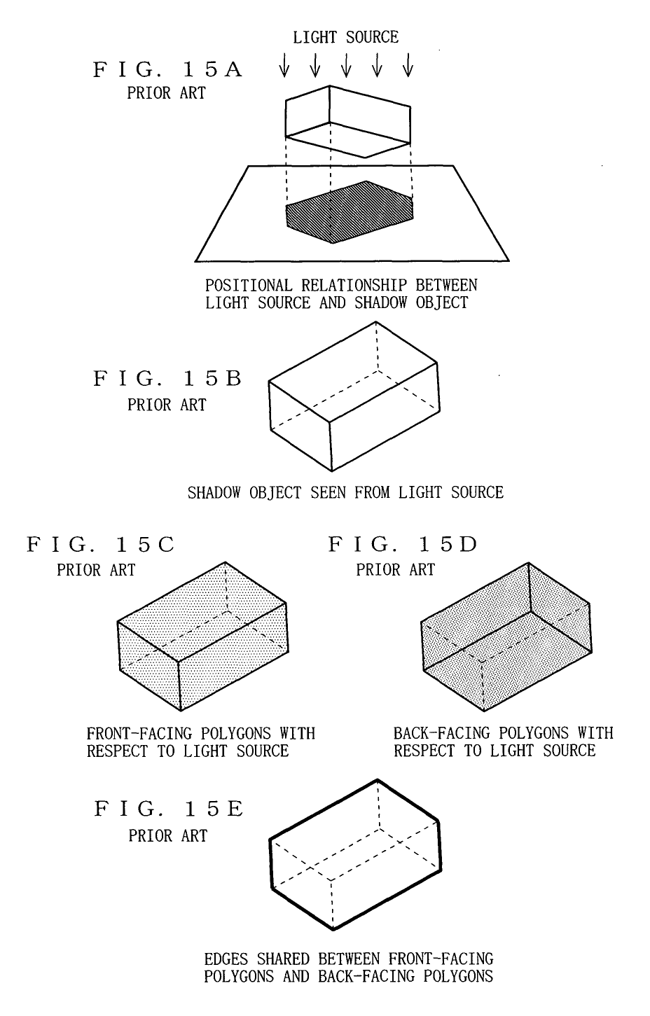

FIGS. 16A to 16F are illustrations showing shapes of outlines extracted by the conventional shadow volume technique.

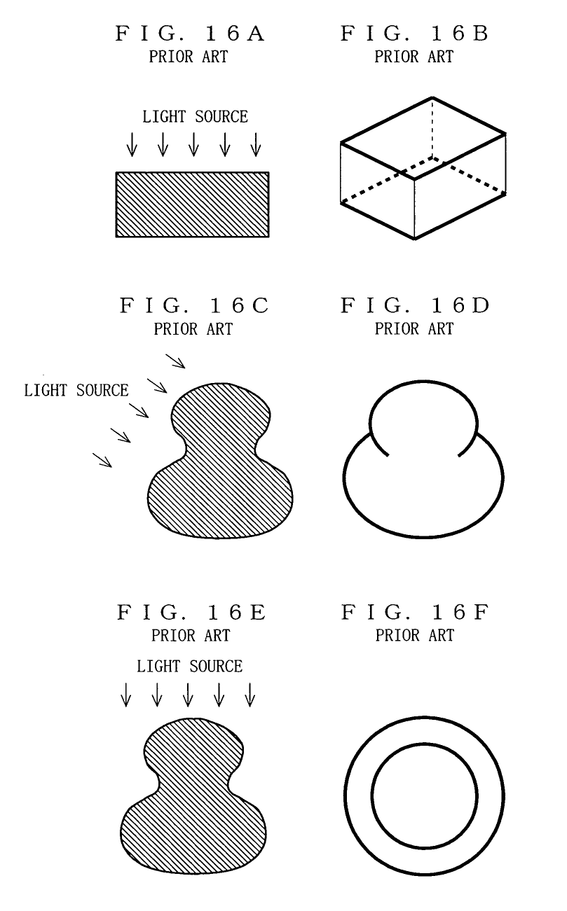

### DESCRIPTION OF THE PREFERRED EMBODIMENTS

First, the principles of the present invention will be described before an embodiment of the present invention is described in detail.

The present invention is based on an idea that a shape of an extremely soft cloth, which covers a shadow object as if hiding the object from light rays emitted from the light source, is utilized as a shape of a shadow volume.

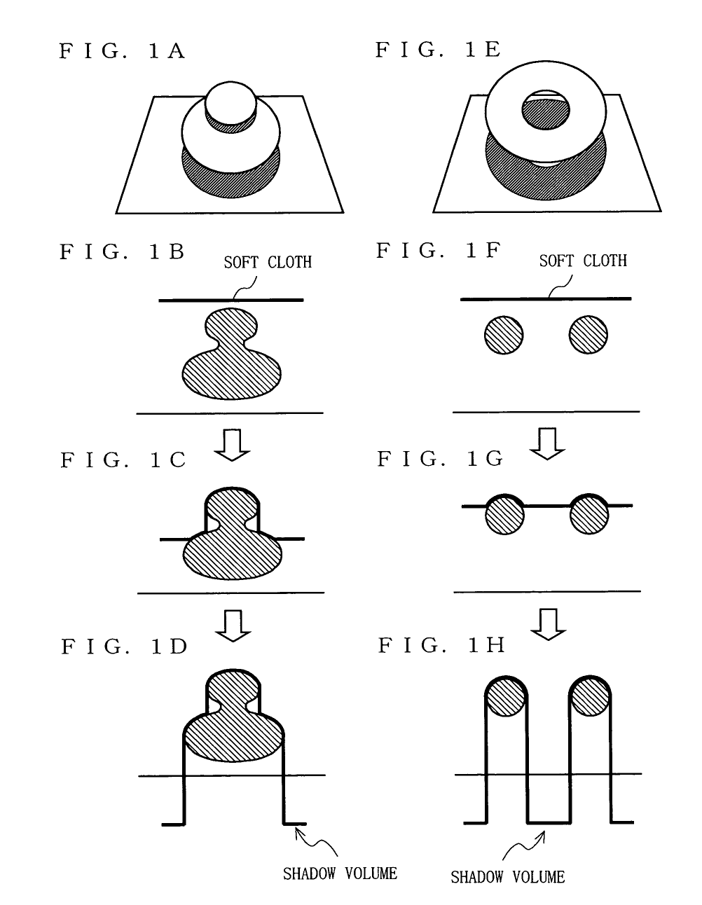

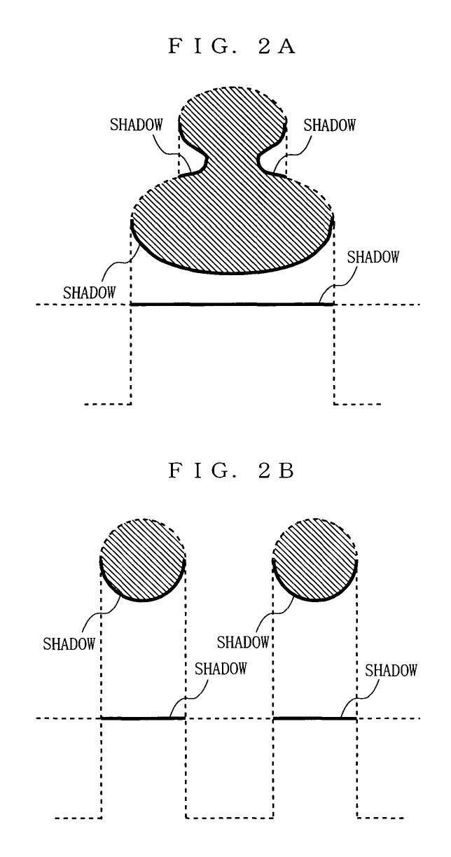

For example, as shown in FIG. 1A, assume that light rays fall on a gourd-shaped shadow object from above. If a soft cloth is spread over the shadow object as if hiding the object from light rays emitted from the light source (FIGS. 1B and 1C), the shadow object is finally covered with the cloth as shown in FIG. 1D. The space covered with the cloth as shown in FIG. 1D coincides with space where light cannot be seen because it is blocked by the gourd-shaped shadow object. Thus, it is possible to obtain a shadow volume of an appropriate shape by utilizing the shape of the cloth as a shape of the shadow volume. As another example, FIGS. 1E to 1H show a case where light rays fall on a doughnut-shaped shadow object. If shadow rendering is performed based on a shadow volume technique using the shadow volumes generated as described above, it is possible to display shadows as shown in FIGS. 2A and 2B in solid line.

Hereinafter, a game system according to an embodiment of the present invention will be described.

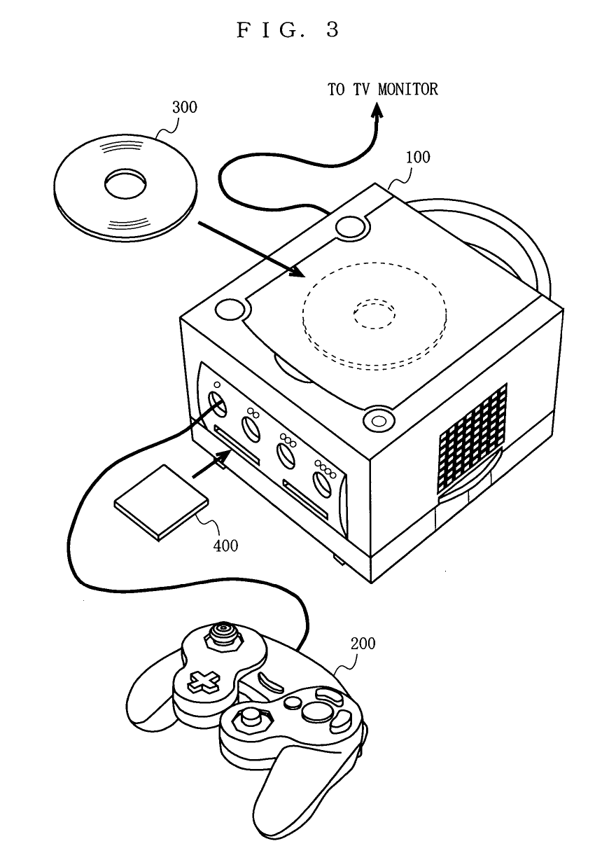

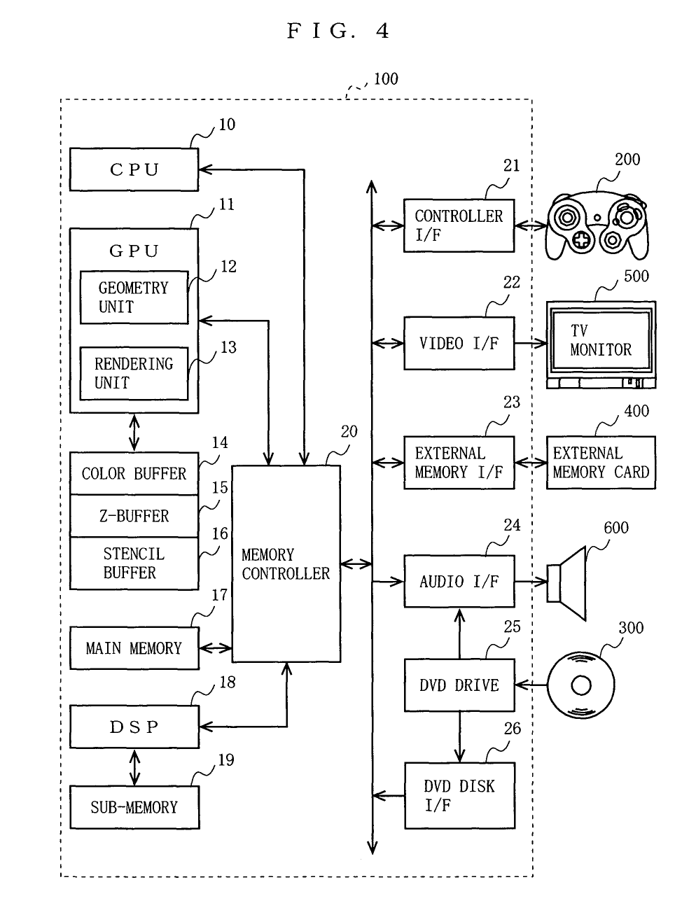

FIG. 3 is an illustration of an external view showing the structure of the game system, and FIG. 4 is a block diagram thereof. As shown in FIGS. 3 and 4, the game system includes a main unit 100, a DVD-ROM 300, an external memory card 400, a controller 200, a loudspeaker 600, and a TV monitor 500. The DVD-ROM 300 and the external memory card 400 are removably mounted on or inserted into the main unit l00, respectively. The controller 200 is connected to any one of a plurality of (in FIG. 3, four) controller port connectors provided to the main unit 100, via a communication cable. The TV monitor 500 and the loudspeaker 600 are connected to the main unit 100 via an AV cable, etc. Note that the main unit 100 and the controller 200 may communicate with each other by radio communications. Hereinafter, with reference to FIG. 4, components of the game system are described in detail.

The DVD-ROM 300 fixedly stores a game program, a shadow volume generation program, which will be described below, and object data, or the like. When a player starts a game, the DVD-ROM 300 is mounted on the main unit 100. Note that an external storage medium such as a CD-ROM, an MO, a memory card, or a ROM cartridge, for example, may be used in place of the DVD-ROM 300 for storing the program, etc.

The external memory card 400 is composed of a rewritable storage medium such as a flash memory, for example, and stores data such as save data, for example, of the game.

The main unit 100 reads the program stored in the DVD-ROM 300, and performs a process in accordance with the read program.

The controller 200 is an input device with which the player performs input with regard to a game operation, and provided with a plurality of operation switches. The controller 200 outputs operation data to the main unit 100 in response to the pressure, etc., of the operation switches exerted by the player.

The TV monitor 500 displays image data output from the main unit 100 on a screen. Note that the loudspeaker 600 is typically build into the TV monitor 500, and outputs an in-progress game sound output from the main unit 100.

Next, the structure of the main unit 100 is described. In FIG. 4, the main unit 100 includes a CPU 10 and a memory controller 20 connected to the CPU 10. In the main unit 100, memory controller 20 is connected to a GPU (graphics processing unit) 11, a main memory 17, a DSP 18, and various interfaces (I/F) 21 to 24, and 26. The memory controller 20 controls data transfer between the above-described components.

When the game is started, a DVD-drive 25 drives the DVD-ROM 300 mounted on the main unit 100. The game program stored in the DVD-ROM 300 is loaded into the main memory 17 via a DVD disk I/F 26 and the memory controller 20. The game is started when the CPU 10 executes the program loaded in the main memory 17. After the game is started, the player uses the operation switches and performs game operation input, for example, for the controller 200. In accordance with the input by the player, the controller 200 outputs operation data to the main unit 100. The operation data output from the controller 200 is input into the CPU 10 via a controller I/F 21 and the memory controller 20. The CPU 10 performs a game process in accordance with the input operation data. The GPU 11 or the DSP 18 is used in image data generation, for example, in the game process. Also, a sub-memory 19 is used when the DSP 18 performs a predetermined process.

The GPU 11, which includes a geometry unit 12 and a rendering unit 13, is connected to a memory dedicated to image processing. The above-described dedicated memory is used, for example, as a color buffer 14, a Z-buffer 15, or a stencil buffer 16. The geometry unit 12 performs arithmetic operations with regard to coordinates of an object placed in a virtual three-dimensional game space or a three-dimensional graphics model (for example, an object composed of polygons). For example, the geometry unit 12 performs rotation, scaling, and transformation of the three-dimensional model, or converts coordinates of a world coordinate system to coordinates of a viewpoint coordinate system or a screen coordinate system. The rendering unit 13 writes color data (RGB data) of each pixel of the three-dimensional model projected onto the screen coordinates into the color buffer 14 based on a predetermined texture, and generates the game image. Also, the color buffer 14 is a memory area for holding game image data (RGB data) generated by the rendering unit 13. The Z-buffer 15 is a memory area for holding information on depth from a viewpoint, which will be lost when three-dimensional viewpoint coordinates are converted into two-dimensional screen coordinates. The stencil buffer 16 is a memory area used in determining a shadow area by the shadow volume technique. The GPU 11 generates image data to be displayed on the TV monitor 500 using those buffers, and outputs the image data to the TV monitor 500 as appropriate via the memory controller 20 and a video I/F 22. Note that sound data generated by the CPU 10 during the execution of the game program is output from the memory controller 20 to the loudspeaker 600 via an audio I/F 24. Note that, in the present embodiment, a memory dedicated to image processing is additionally included in the hardware structure, but a method (UMA: Unified Memory Architecture) utilizing a portion of the main memory 17, for example, as a memory dedicated to image processing may be used.

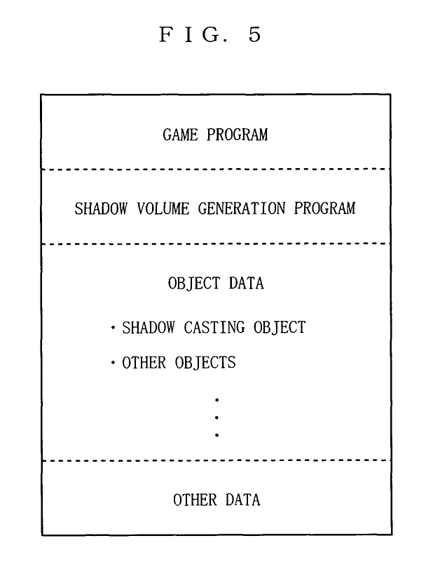

A memory map of the DVD-ROM 300 is shown in FIG. 5. The DVD-ROM 300 stores the game program, the shadow volume generation program, and the object data, etc. Note that the shadow volume generation program maybe included in the game program. The object data includes data about a shadow casting object and other objects.

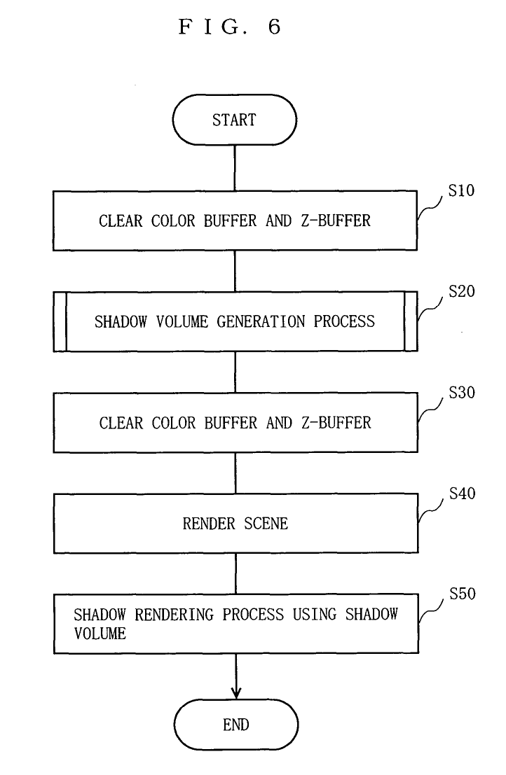

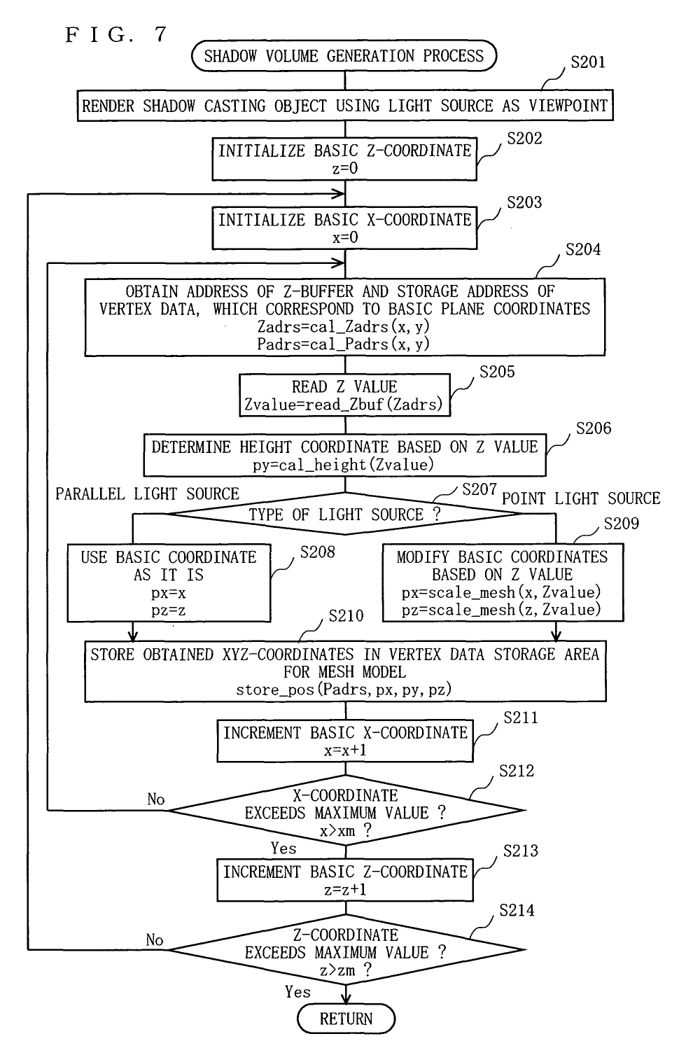

Hereinafter, with reference to flowcharts of FIGS. 6 and 7, an shadow rendering operation of the present game system is described.

In FIG. 6, when a shadow rendering process is started, the CPU 10 first clears the color buffer 14 and the Z-buffer 15 (step S10). Next, based on the above-described shadow volume generation program, the CPU 10 executes a shadow volume generation process (step S20). Hereinafter, details of the above-described shadow volume generation process are described with reference to FIG. 7.

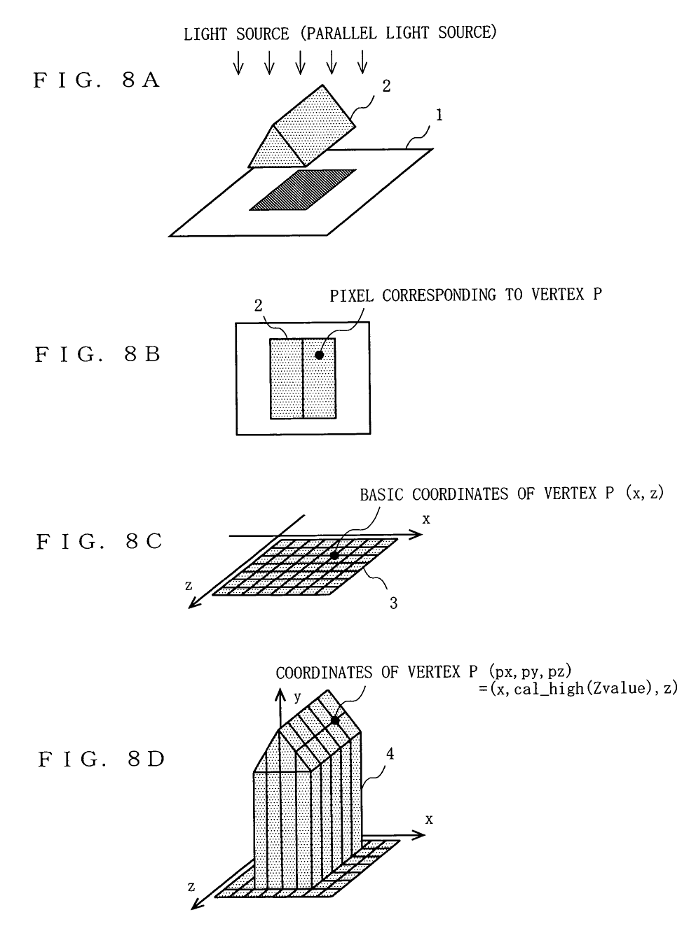

In FIG. 7, when the shadow volume generation process is started, the GPU 11 renders only the shadow casting object, using the light source placed in a virtual space as a viewpoint (step S201). That is, as shown in FIG. 8A, in the case where light rays fall on a shadow casting object 2, which is suspended above a board 1, from directly above, the GPU 11 renders a scene in which the shadow casting object 2 is seen from directly above. As a result, two-dimensional image data shown in FIG. 8B is written into the color buffer 14, and a Z value (a value corresponding to a distance from the viewpoint to the object) corresponding to each pixel of the two-dimensional image data is written into the Z-buffer 15. Note that, in the above descriptions, it is assumed that the two-dimensional image data is written into the color buffer 14 for sake of simplicity. However, what is really needed is to write the Z value into the Z-buffer 15. Thus, there is no need to write the image data into the color buffer 14.

When rendering at step S201 is completed, the CPU 10 executes a process for generating a mesh model 4 shown in FIG. 8D from a plane object 3 (corresponds to the soft cloth shown in FIG. 1B) shown in FIG. 8C by the following steps S202 to S214. In the present embodiment, the above-described mesh model 4 is used as a shadow volume.

The plane object 3 is composed of a plurality of polygons, and provided with a plurality of vertices, which are also vertices of the plurality of polygons. The position of each vertex is defined by a combination of an X-coordinate and a Z-coordinate. In the present embodiment, it is assumed that the coordinates of vertices of the plane object 3 are defined as follows.

$$\begin{matrix}( 0 , 0 ) , & ( 1 , 0 ) , & ( 2 , 0 ) , ⋯ , & ( xm , 0 ) \\ ( 0 , 1 ) , & ( 1 , 1 ) , & ( 2 , 1 ) , ⋯ , & ( xm , 1 ) \\ ( 0 , 2 ) , & ( 1 , 2 ) , & ( 2 , 2 ) , ⋯ , & ( xm , 2 ) \\ ( 0 , 3 ) , & ( 1 , 3 ) , & ( 2 , 3 ) , ⋯ , & ( xm , 3 ) \\ ⋮ & ⋮ & ⋮ & ⋮ \\ ( 0 , zm ) , & ( 1 , zm ) , & ( 2 , zm ) , ⋯ , & ( xm , zm )\end{matrix}$$

Note that, in the following descriptions, it is assumed that coordinates (x, y) of a vertex of the plane object 3, which becomes a vertex P of the mesh model 4, are referred to as basic coordinates of the vertex P of the mesh model 4. Also, an X-coordinate and a Z-coordinate of the basic coordinates are referred to as a basic X-coordinate and a basic Z-coordinate, respectively.

Hereinafter, a process after step S202 will be described in a concrete manner.

The following are descriptions of variables used in the flowchart of FIG. 7. Variables x and z indicate the basic X-coordinate and the basic Z-coordinate, respectively, and variables xm and zm indicate a maximum value of the basic X-coordinate and a maximum value of the basic Z-coordinate, respectively. A variable Zadrs indicates an address of the Z-buffer 15, and avariable Zvalue indicates a value of the Z-buffer 15. A variable Padrs indicates an address of the main memory 17 storing the vertex coordinates of the mesh model 4, and variables px, py, and pz indicate an X-coordinate, a Y-coordinate, and a Z-coordinate of the mesh model 4, respectively.

Also, the following are descriptions of functions used in the flowchart of FIG. 7. A function cal_Zadrs ( ) is used for obtaining an address of the Z-buffer 15, which corresponds to the basic coordinates. A function cal_Padrs ( ) is used for obtaining a vertex data storing address of the mesh model 4, which corresponds to the basic coordinates. A function read_Zbuf ( ) is used for reading a Zvalue from the Z-buffer address. A function cal_height ( ) is used for calculating an appropriate height value based on the Z value. A function scale_mesh ( ) is used for modifying the basic X-coordinate or the basic Z-coordinate so that each vertex of the mesh model 4 is moved in a radial pattern in accordance with the Z value (that is, so that each vertex is changed proportionate to the Z value, changed exponentially in accordance with the Z value, or changed at a predetermined rate of increase in accordance with the Z value based on a prepared conversion table). A function store_pos ( ) is used for storing the X-axis, the Y-axis, and the Z-axis into a vertex data storage area of the mesh model 4.

At step S202, the CPU 10 initializes the basic Z-coordinate, and initializes the basic X-coordinate at the following step S203. That is, among a plurality of vertices defining a shape of the mesh model 4, a vertex whose basic coordinates are (0, 0) is selected as a vertex to be processed first.

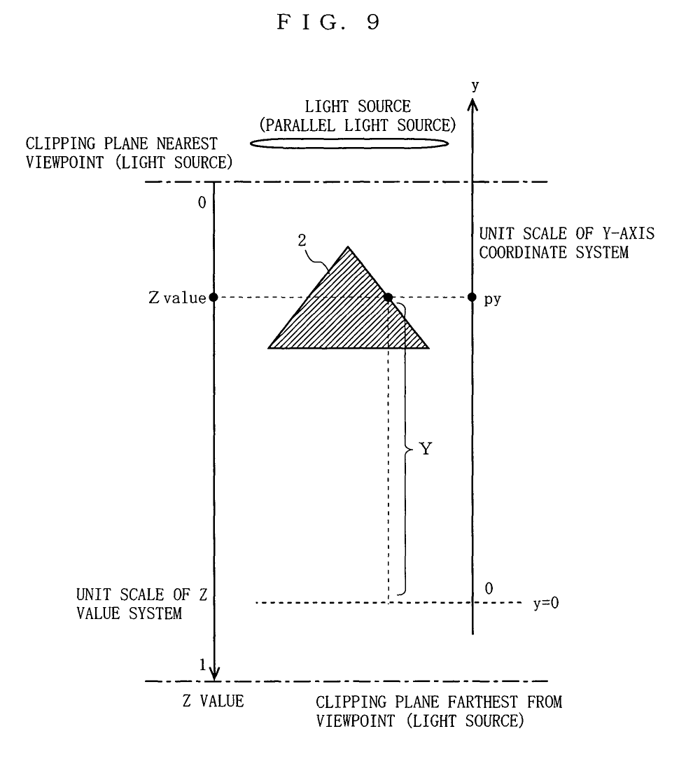

At step S204, the CPU 10 obtains, based on the basic coordinates (x, y) of the processing vertex, an address of the Z-buffer 15 and a storage address of vertex data, which correspond to the above-described basic coordinates. Then, the CPU 10 reads a Z value of the obtained address of the Z-buffer 15 (step S205). That is, among the pixels composing the two-dimensional image shown in FIG. 8B, which are stored in the color buffer 15, a Z value of the pixel corresponding to the processing vertex is read from the Z-buffer 15. Based on the read Z value, the CPU 10 determines a Y-coordinate of the processing vertex (that is, a position with regard to a direction perpendicular to a surface of the plane object 3) (S206). In order to obtain the Y-coordinate (py) of the processing vertex based on the Z value, for example, as shown in FIG. 9., what is required is to obtain a difference between a Z value (for example, “1” in FIG. 9) placed in a clipping plane farthest from the viewpoint (light source) and the rendered Z value (Zvalue), and scale the obtained difference according to a unit system of the Y-axis coordinate.

After the Y-coordinate of the processing vertex is determined at step S206, the CPU 10 determines whether the light source is a parallel light source or a point light source (step S207). If the determination is made that the light source is a parallel light source, the CPU 10 proceeds to step S208. On the other hand, if the determination is made that the light source is a point light source, the CPU 10 proceeds to step S209. It is needless to say that step S207 is unnecessary in a system having only either a parallel light source or a point light source.

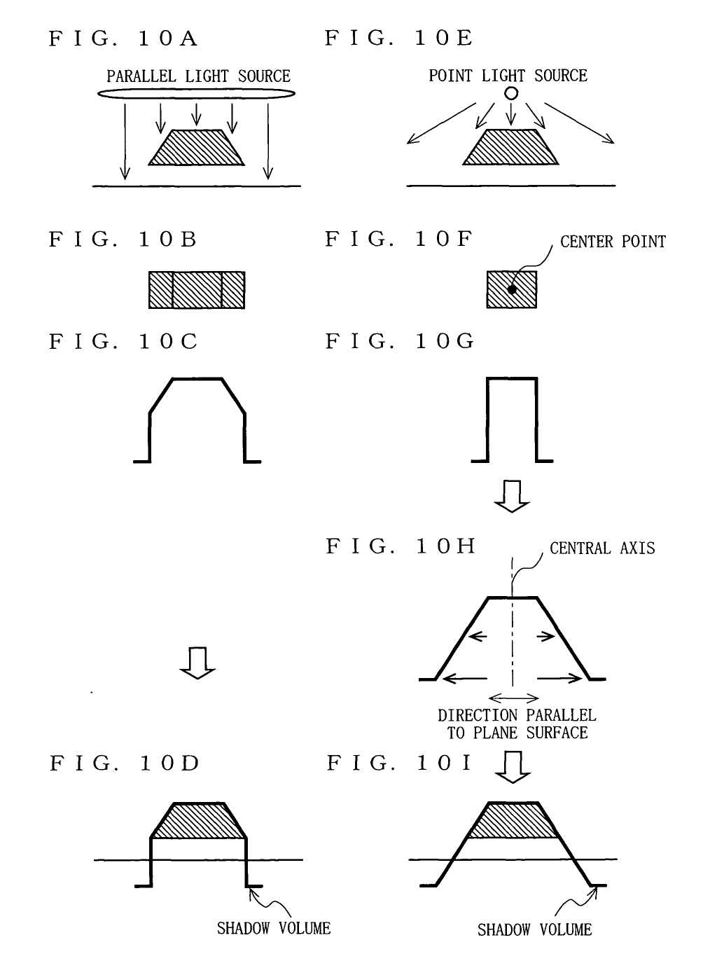

In the case where the light source is a parallel light source, the basic X-coordinate (x) and the basic Z-coordinate (z) are used as it is as an X-coordinate (px) and a Z-coordinate (pz) of the processing vertex, respectively, as shown in FIG. 8D (step S208). On the other hand, in the case where the light source is a point light source, a basic X-coordinate (x) and a basic Z-coordinate (z), which are modified in accordance with the Z value (Zvalue) read at step S205, are set as an X-coordinate (px) and a Z-coordinate (pz) of the processing vertex, respectively (step S209). As such, a process is changed depending on the type of light source for a reason which will be described below with reference to FIG. 10.

As shown in FIG. 10A, in the case where a shadow casting object is illuminated by a parallel light source, an orthogonal projection in which an object will be the same size no matter how far it is from a light source is used for rendering the shadow casting object in a rendering process at step S201. On the other hand, in the case where the shadow casting object is illuminated by a point light source, a perspective projection in which objects further away from a light source are smaller than objects that are closer to the light source is used for rendering the shadow casting object in a rendering process at step S201, as shown in FIG. 10E. As a result, as shown in FIGS. 10B and 10F, two-dimensional image data to be stored in the color buffer 14 has different contents depending on whether a light source is a parallel light source or a point light source. The same goes for contents of the Z value to be stored in the Z-buffer 15. As a result of executing step S206 based on the above-described Z value, a position with regard to a direction perpendicular to a surface of the plane object is determined as shown in FIG. 10C in the case of a parallel light source, and determined as shown in FIG. 10G in the case of a point light source. In the case of a parallel light source, it is possible to use a mesh model shown in FIG. 10C as a shadow volume as shown in FIG. 10D. However, in the case of a point light source, it is impossible to use a mesh model shown in FIG. 10G as a shadow volume. That is, in the case of a point light source, the basic X-coordinate or the basic Z-coordinate is modified so that each vertex of the mesh model is moved in a radial pattern with regard to a direction parallel to a surface of a plane object 3 in accordance with the Z value (that is, so that the vertex further away from the light source is moved over greater distances), as shown in FIG. 10H. Note that a central axis of the above-described radial movement corresponds to a central point of the two-dimensional image generated when the shadow casting object is rendered using the light source as a viewpoint at step S201. The mesh model generated as described above can be used as a shadow volume as shown in FIG. 10I.

After the X-coordinate and the Z-coordinate of the processing vertex are determined at step S208 or step S209, the CPU 10 stores the coordinates of the processing vertex into the address obtained at step S204 (step S210). Then, the CPU 10 increments the basic X-coordinate (x) (step S211), and repeats a process from step S204 to step S212 while sequentially changing a processing vertex until the basic X-coordinate exceeds the maximum value (xm) (“NO” at step S212). When the basic X-coordinate exceeds the maximum value (“YES” at step S212), the CPU 10 increments the basic Z-coordinate (z) (step S213), and determines whether or not the basic Z-coordinate exceeds the maximum value (zm) (step S214). If the determination is made that the basic Z-coordinate does not exceed the maximum value (“NO” at step S214), the CPU 10 goes back to step S203. On the other hand, if the determination is made that the basic Z-coordinate exceeds the maximum value (indicating that vertex data of all vertices of the mesh model 4 is stored in the main memory 17), the CPU 10 ends the shadow volume generation process, and goes back to a process of the flowchart shown in FIG. 6.

In FIG. 6, when the shadow volume generation process is completed, the GPU 11 clears the Z-buffer and, if necessary, the color buffer 14 (step S30), and renders a scene (step S40). At step S40, a regular rendering process is performed. As a result, the board 1 and the shadow casting object 2 as shown in FIG. 8A, for example, are rendered.

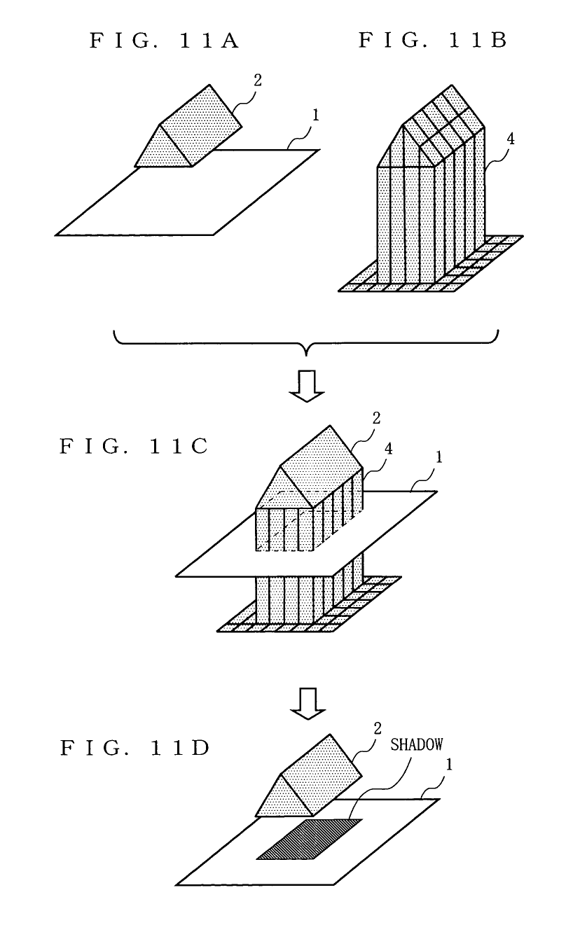

After completion of the above-described scene rendering, the GPU 11 uses the mesh model 4 generated at step S20 as a shadow volume, and executes a shadow rendering process by the shadow volume technique. Specifically, in a virtual space as shown in FIG. 1A, the mesh model 4 as shown in FIG. 11B is placed in a virtual manner as shown in FIG. 1C, and a shadow area as shown in FIG. 11D is extracted by the shadow volume technique using the stencil buffer 16.

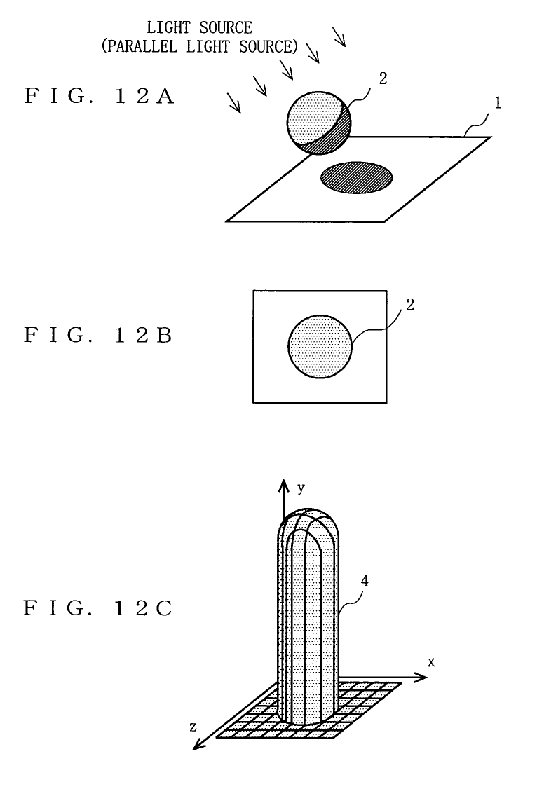

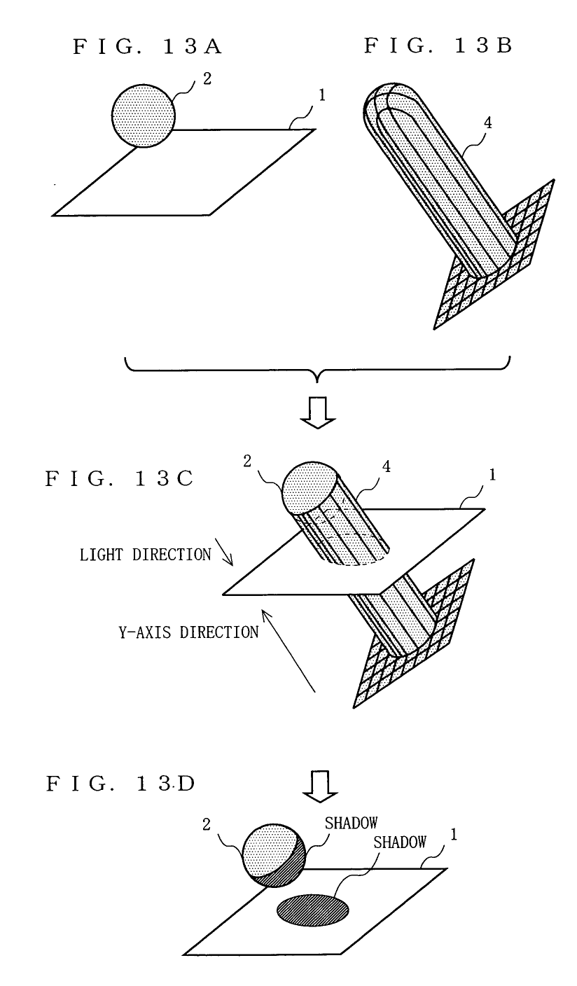

Note that, in the present embodiment, a case where light rays fall on the shadow casting object 2 from above has been described. However, the present invention can also be applied to a case where slanting light rays fall on the shadow casting object 2. For example, as shown in FIG. 12A, in the case where slanting light rays fall on the ball-shaped object 2 casting a shadow, a two-dimensional image obtained by rendering the above-described shadow casting object 2 using the light source as a viewpoint is shown in FIG. 12B. Then, based on the Zvalue written in the Z-buffer 15 as a result of the above-described rendering, a position of each vertex is determined with regard to a direction perpendicular to a surface of the plane object 3, and the mesh model 4 as shown in FIG. 12C is finally obtained. In the case where shadow rendering is performed using the obtained mesh model 4 as a shadow volume, the mesh model 4 as shown in FIG. 13B is placed in a virtual manner as shown in FIG. 13C in a virtual space as shown in FIG. 13A. That is, the mesh model 4 is placed so that a height direction (that is, a Y-axis direction) thereof coincides with the light direction. Then, a shadow area as shown in FIG. 13D is extracted by the shadow volume technique using the stencil buffer 16.

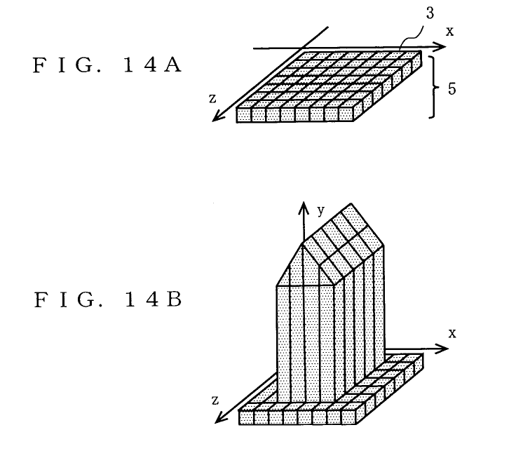

Also, in the present embodiment, it is assumed that a shadow volume is generated based on the plane object 3. The above-described plane object 3 may be, for example, one side of a three-dimensional object 5 as shown in FIG. 14A. Also in this case, as is the case with the present embodiment, a position of each vertex is determined with regard to a direction perpendicular to a surface of the plane object 3, based on the Z value written in the Z-buffer 15, thereby obtaining a shadow volume as shown in FIG. 14B, and performing shadow rendering using the obtained shadow volume.

As described above, according to the present embodiment, it is possible to generate a shadow volume of any shape by a fixed process, irrespective of how complex shape the shadow casting object has. As a result, no exception handling occurs, thereby minimizing the amount of a program and realizing stable processing. Furthermore, it is possible to execute the process of the present embodiment using a function of a graphics processor. As a result, a processing speed can be substantially improved by causing the graphics processor to perform the above-described process.

Note that, in the present invention, it is assumed that the game program is supplied to the main unit 100 via the DVD-ROM 300. However, the game program maybe stored in a computer-readable storage medium other than the DVD-ROM 300 (for example, a CD-ROM, an MO, a memory card, and a ROM cartridge) and supplied to the main unit 100. Also, the game program may be previously included in the main unit 100, or supplied to the main unit 100 via a communication line such as an Internet.

While the invention has been described in detail, the foregoing description is in all aspects illustrative and not restrictive. It is understood that numerous other modifications and variations can be devised without departing from the scope of the invention.

What is claimed is:

1. A computer-readable storage medium for storing a shadow volume generation program that causes a computer to generate a shadow volume used for rendering a shadow cast by an object placed in a three-dimensional virtual space, wherein the shadow volume generation program causes the computer to execute the steps of:
writing a Z value corresponding to each pixel within a predetermined area including at least the shadow casting object, into a Z-buffer, using a light source placed in the virtual space as a viewpoint; and
generating the shadow volume from a plane object by determining a position of each vertex of a plurality of polygons composing the plane object, with regard to a direction perpendicular to a surface of the plane object in accordance with the Z value of each pixel written in the Z-buffer.

2. A storage medium according to claim 1, wherein
a shape of the plane object is defined by a plurality of vertices, each having different combination of an X-coordinate and a Z-coordinate, and
in the shadow volume generation step, a Y-coordinate of each vertex of the plane object is determined in accordance with the Z value of each pixel written in the Z-buffer.

3. The storage medium according to claim 1, wherein
the light source is a point light source, and
the shadow volume generation step includes a step of determining a position of each vertex of the plane object with regard to a direction parallel to a surface thereof in accordance with the Z value of each pixel written in the Z-buffer.

4. The storage medium according to claim 3, wherein
a shape of the plane object is defined by a plurality of vertices, each having a different combination of an X-coordinate and a Z-coordinate, and
in the shadow volume generation step, the X-coordinate and the Z-coordinate of each vertex of the plane object are determined in accordance with the Z value of each pixel written in the Z buffer.

5. The storage medium according to claim 1, wherein
the shadow volume generation program further causes the computer to execute the steps of:
placing the shadow volume generated at the shadow volume generation step in the virtual space in a virtual manner so that a height direction of the shadow volume coincides with a direction of light emitted from the light source, and
rendering the shadow of the shadow casting object using the shadow volume placed in a virtual manner.

6. A game device for generating a shadow volume used for rendering a shadow cast by an object placed in a three-dimensional virtual space, comprising:
a Z-buffer;
a Z value writing means for writing a Z value of each pixel within a predetermined area including at least the shadow casting object, into the Z-buffer, using a light source placed in the virtual space as a viewpoint; and
a shadow volume generation means for generating the shadow volume from a plane object by determining a position of each vertex of a plurality of polygons composing the plane object, with regard to a direction perpendicular to a surface of the plane object in accordance with the Z value of each pixel written in the Z-buffer by the Z value writing means.

7. A shadow volume generation method for generating a shadow volume used for rendering a shadow cast by an object placed in a three-dimensional virtual place, comprising the steps of:
writing a Z value of each pixel within a predetermined area including at least the shadow casting object, into the Z -buffer, using a light source placed in the virtual space as a viewpoint; and
generating the shadow volume from a plane object by determining a position of each vertex of a plurality of polygons composing the plane object with regard to a direction perpendicular to a surface of the plane object in accordance with the Z value of each pixel written in the Z-buffer.
